(19) United States
(12) Patent Application Publication
(10) Pub. No.: US 2003/0067161 A1
(43) Pub. Date: Apr. 10, 2003

(54) Hydraulic swivel connector

(76) Inventors: Merle L. Smith, Blue Ash, OH (US); Wayne Busdiecker, West Carrolton, OH (US)

Correspondence Address: Frost Brown Todd LLC, 2200 PNC Center, 201 East Fifth Street, Cincinnati, OH, 45202, US

(21) Appl. No.: 10/295,634

(22) Filed: Nov. 15, 2002

Related U.S. Application Data
(63) Continuation of application No. 09/621,862, filed on Jul. 21, 2000, now abandoned.
(60) Provisional application No. 60/144,749, filed on Jul. 21, 1999.

(51) Int. Cl. F16L 27/00

(52) U.S. Cl. 285/276

(57) ABSTRACT

The hydraulic swivel connector generally consists of a swivel spud that includes an interior surface and an exterior surface. The exterior surface of the swivel spud preferably includes a first region with a relatively small diameter, a second region having a diameter somewhat greater than the diameter of the first region, and a third region having a diameter somewhat larger than the second diameter of the exterior surface of the swivel spud. The second region preferably comprises an externally disposed circumferential groove adapted to receive a snap ring. The hydraulic swivel connector also includes a connector end component that includes an interior surface and an exterior surface. The connector end component is adapted to receive at least a portion of the swivel spud. The interior surface of the connector end component includes a first region having a first diameter, a second region having a second diameter greater than the first diameter, of the connector end component, and a third region having a third diameter greater than the second diameter of the connector end component. The third region of the interior surface of the connector end component also includes an internally disposed circumferential groove adapted to receive the snap ring. An o-ring is provided and disposed between the swivel spud and the connector end component to prevent undesirable fluid flow. The snap ring is seated in the circumferential grooves so as to retain the swivel spud rotatably within the connector end component.

This application claims priority benefit of U.S. Provisional Patent Application Serial No. 60/144,749, filed Jul. 21, 1999, the entire specification of which is incorporated herein by reference.

### TECHNICAL FIELD

This invention relates generally to connectors for hydraulic systems and, more particularly, to fluid swivel couplings for the passage of fluids.

### BACKGROUND OF THE INVENTION

Rotary and swivel couplers are frequently utilized to connect fluid conduits together. These rotating devices are especially useful when connecting a fluid conduit to a rotating or pivoting device. The swivel coupling, which may rotate about the axis of the input fluid conduit or alternatively, may rotate about a perpendicular axis, is especially useful where maneuverability is essential to the satisfactory operation of the device.

Some swivel couplings consist of a swivel body having an internal cavity. An internal fluid passageway interconnects the cavity with a port which is adapted for interconnection with a fluid conduit. A tubular rotating member is engaged within the cavity. A second fluid passageway, which passes through the rotating member, interconnects the first fluid passageway and a second port for connection with a second fluid conduit. A bearing is disposed between the rotating member and the cavity to allow for the rotation of the rotating member. Such an assembly may include a seal to prevent passage of fluid from between the rotating member and the cavity and means for preventing the axial movement of the rotating member from within the cavity.

Hydraulic systems typically include a means of conveying a hydraulic fluid medium from one point to another. Typical conveyance devices known in the art include various sized tubing, pipes, and hoses. These conveyance devices may be made of metal, rubber, plastic, glass, or essentially any material suitable for the relevant operating conditions and particular requirements of the hydraulic system.

Flexible metal hose is often the conveyance apparatus of choice when the hydraulic fluid medium is corrosive or if the working environment is hostile to rubber plastic hose products, such as environments of extreme temperatures. Flexible metal hoses have been found to be a desirable alternative to rigid piping or tubing. One typical use of such a flexible metal hose is exhibited within the steel industry when coolant is supplied to the rollers of a continuous cast mill. Typical designs of the rollers require the use of a rotary joint and a fluid which is both hot and corrosive (such as polluted steam). In such a system, the rotary joint is often plumbed to the hydraulic system with flexible metal hose and common end connections.

Metal hose assemblies typically connect individual hydraulic system components, for example, a fluid coolant pump to cooling rollers. Further, metal hose assemblies are typically attached to the individual system components via industry recognized standard connections such as threaded pipe ends. The use of such standardized connections usually requires the use of additional hydraulic adapters to provide a means of completing the hose assembly connection. Adding an adapter to the hose assembly may disadvantageously shorten the effective working length of the metal hose within the confines of the hose assembly due to the rigidity of such adapters. Shortening the effective length of the hose not only makes the hose assembly more rigid it may require the use of additional adapters in order to safely route the hose within the parameters of the hydraulic system. Accordingly, metal hose assemblies with short lengths of hose frequently cause installation difficulties. Similarly, unduly short hose assemblies usually result in hose which has inherent stresses applied to the hose which may result in premature failure. Likewise, hose assemblies with shortened lengths of free, flexible hose yields a stiff hose assembly which is unable to dissipate stress which may lead to system failure.

### SUMMARY OF THE INVENTION

Accordingly, it is a primary object of the present invention to provide a hydraulic swivel connector that overcomes the disadvantages associated with the above-described prior art. Still other objects of the present invention will become apparent to those skilled in this art from the following description and drawing wherein there is described and shown a preferred embodiment of the invention. As will be realized, the invention is capable of other different embodiments, and its several details are capable of modification in various, obvious aspects all without departing from the invention. Accordingly, the drawings and descriptions will be regarded as illustrative in nature and not as restrictive.

To achieve the foregoing and other objects, and in accordance with one aspect of the present invention, an improved hydraulic swivel connector is provided. The hydraulic swivel connector generally consists of a swivel spud that includes an interior surface and an exterior surface. The exterior surface of the swivel spud preferably includes a first region with a relatively small diameter, a second region having a diameter somewhat greater than the diameter of the first region, and a third region having a diameter somewhat larger than the second diameter of the exterior surface of the swivel spud. The second region preferably comprises an externally disposed circumferential groove adapted to receive fastener means.

The hydraulic swivel connector also includes a connector end component that includes an interior surface and an exterior surface. The connector end component is adapted to receive at least a portion of the swivel spud. The interior surface of the connector end component includes a first region having a first diameter, a second region having a second diameter greater than the first diameter, of the connector end component, and a third region having a third diameter greater than the second diameter of the connector end component. The third region of the interior surface of the connector end component also includes an internally disposed circumferential groove adapted to receive fastener means. Sealing means is provided and disposed between the swivel spud and the connector end component to prevent undesirable fluid flow. Fastener means such as a snap ring is seated in the circumferential grooves so as to retain the swivel spud rotatably within the connector end component.

### BRIEF DESCRIPTION OF THE DRAWINGS

The accompanying drawings incorporated in and forming a part of the specification illustrates several aspects of the present invention, and together with the description and claims serves to explain the principles of the invention. In the accompanying drawings:

FIG. 1 is a side perspective view of the hydraulic swivel connector of the present invention shown attached to a segment of flexible hose;

FIG. 2 is a side perspective view showing the swivel spud component of the hydraulic swivel connector of the present invention disposed on a segment of flexible hose;

FIG. 3 is a side perspective view of the swivel spud after it has been welded to a length of flexible hose;

FIG. 4 is a side perspective view of the swivel spud component of the hydraulic swivel connector of the present invention;

FIG. 5 is a side plan view of a typical snap ring used in the hydraulic swivel connector of the present invention;

FIG. 6 is a side plan view of a typical o-ring for use with the swivel connector system of the present invention;

FIG. 7 is a cut away side view of the hydraulic swivel connector of the present invention;

FIG. 8A is a cut away side view of the swivel spud component of the hydraulic swivel connector of the present invention;

FIG. 8B is an enlarged cut away view of a portion of the swivel spud designated by line A-A of FIG. 8; and

FIG. 9 is a cut away side view of the connector end component of the hydraulic swivel connection of the present invention.

### DETAILED DESCRIPTION OF THE PREFERRED EMBODIMENT

One application of the present hydraulic swivel connector invention is particularly well suited for use with flexible metal hoses. The invention will be discussed as embodied in such a system but it will be appreciated that the invention has wider application.

Reference will now be made in detail to the present preferred embodiment of the invention, an example of which is illustrated in the accompanying drawings, wherein like numerals indicate corresponding elements throughout the figures.

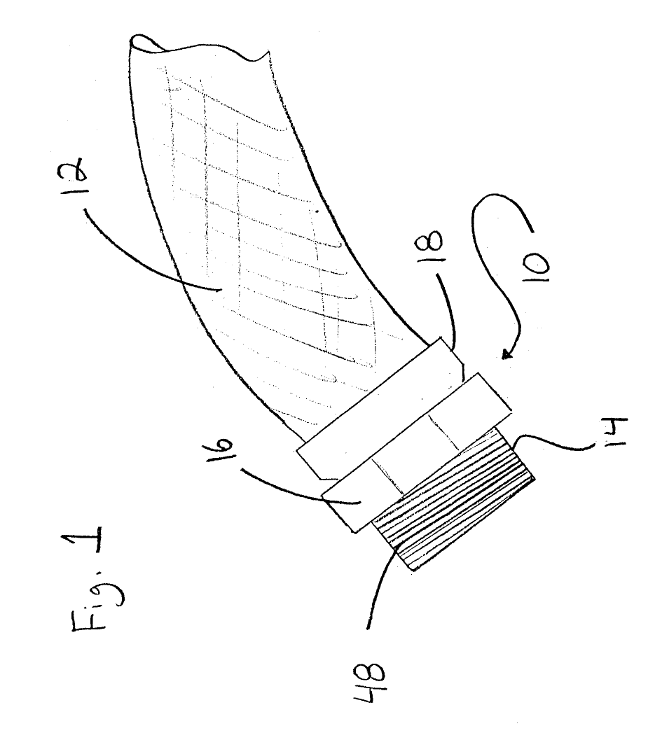

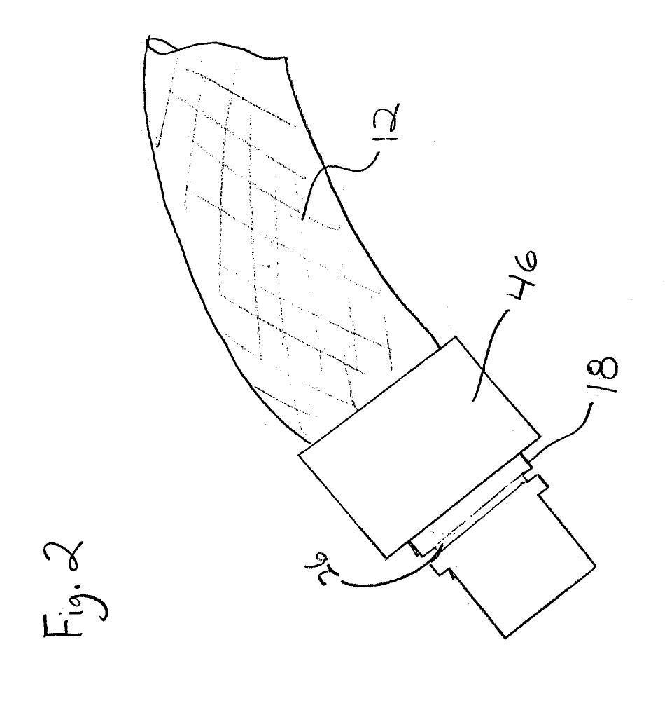

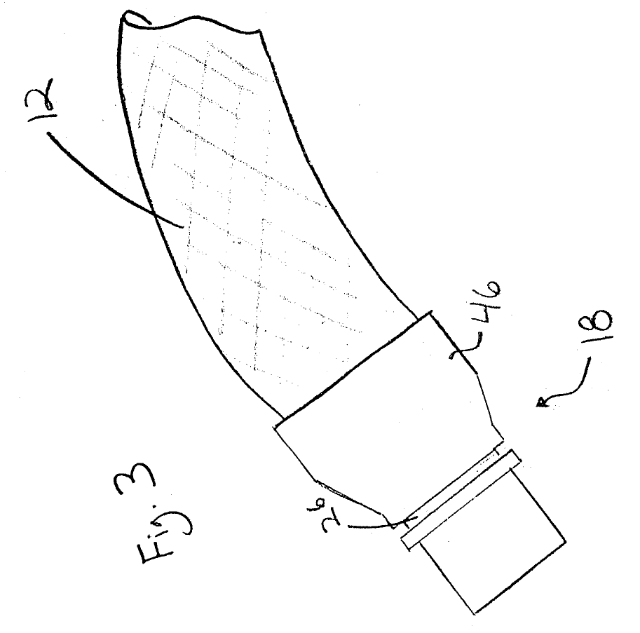

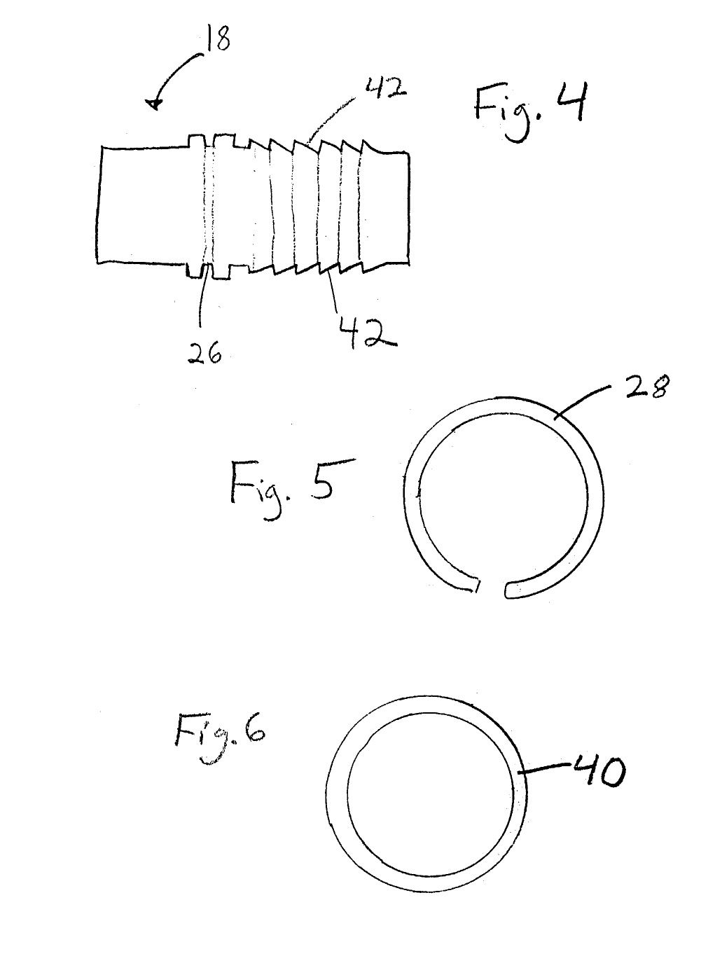

FIG. 1 illustrates generally at 10 the hydraulic swivel connector of the present invention as described hereinafter. As it will be understood, one application of the present hydraulic swivel connector invention is particularly well suited for use with flexible metal hoses. The invention will be discussed and shown as embodied in such a system, but it will be appreciated that the invention has wider application. As shown in FIGS. 1-9, the improved hydraulic swivel connector of the present invention includes a swivel spud 18 that is attached, preferably by welding, to a fluid conduit or hose 12. The swivel spud 18 preferably includes a substantially cylindrical portion and includes an exterior surface and an interior surface. As best shown in FIG. 2, the swivel spud 18 may initially consist of two separate components. Specifically, collar or shell 46 may be slit over hose 12 towards the end of the hose. As best shown in FIG. 4, swivel spud 18 may include a plurality of barbs 42 that are received within the hose 12. Shell or collar 46 may be used to crimp the barbs 42 of the swivel spud 18 to the hose 12. The forward portion of collar 46 is preferably welded to the portion of the swivel spud shown in FIG. 4 after the barb portion 42 of the swivel spud has been inserted into the length of hose 12. FIG. 3 best shows the unified swivel spud 18 after collar 46 has been welded thereto.

As best shown in FIG. 8A, the outer circumferential surface of the swivel spud preferably has a stepped profile. Specifically, the swivel spud 18 preferably includes a first exterior surface region 20, a second exterior surface region 22, and a third exterior surface region 24. The first exterior surface region 20 has a smaller diameter than regions 22 and 24. Second exterior surface region 22 has a diameter greater than that of region 20 but less than that of region 24. Additionally, as shown in FIG. 8A, the second region further includes an external circumferential groove 26 adapted to receive fastening means such as a snap ring (see FIG. 5). Preferably, the third exterior region 24 has the greatest diameter as a result of collar or shell 46 having been welded to form an integral part of swivel spud 18.

As best shown in FIG. 9, the hydraulic swivel connector 10 of the present invention further includes a connector end component 14. The connector end component includes an interior surface and an exterior surface. As can be seen in FIG. 9, the interior surface of the connector end component 14 includes a first region 32 having a first relatively small internal diameter, a second region 34 having a second diameter greater than the first diameter 32 of region 32, and a third region 36 having a diameter greater than the diameters of both sections 34 and 32. Accordingly, the internal cross-section configuration of the connector end component 14 has a stepped profile. The third region 36 preferably includes an internal circumferential groove 38 adapted to receive fastener means such as a snap ring 28.

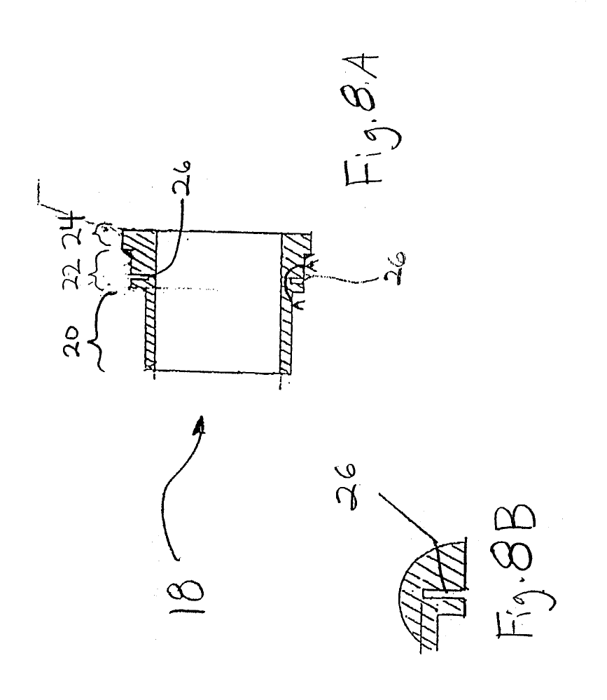

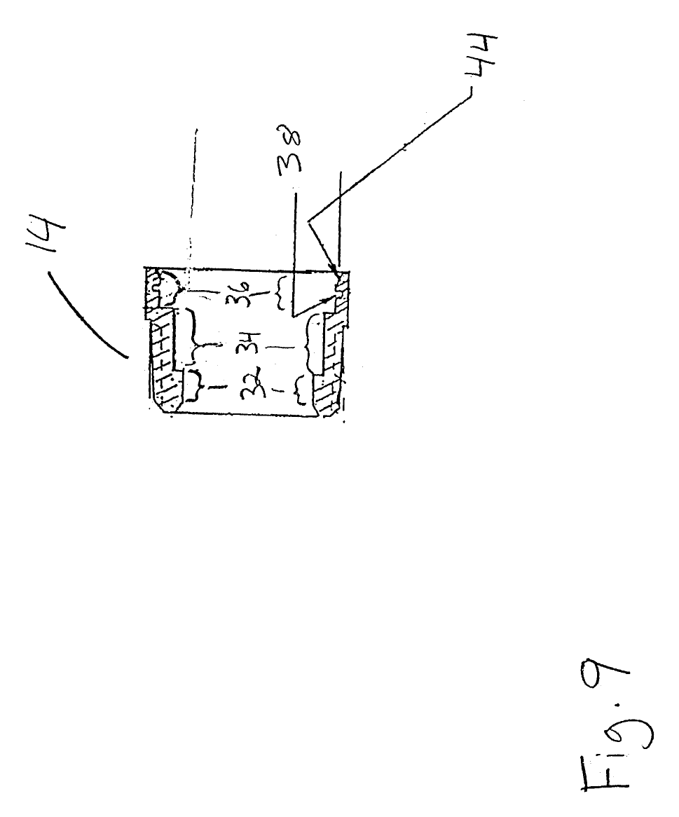

As best shown in FIG. 7, at least a portion of the swivel spud 18 is adapted to be rotatably received within the connector end component 14. The fastener means or snap ring 28 is disposed in the grooves 38 and 26 so as to rotatably retain the swivel spud within the connector end component.

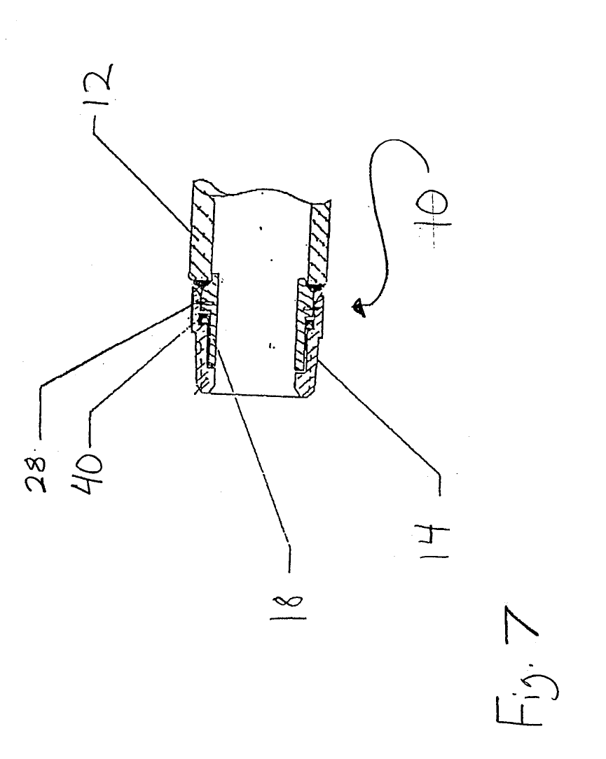

As can be seen in FIG. 7, the stepped internal configuration of the connector end component 14 substantially corresponds with and mates with the outer stepped configuration of the swivel spud 14. As can be seen in FIG. 7, sealing means such as an o-ring 40 (see FIG. 6) may be disposed about the swivel spud and within the connector end component 14 so as to prevent undesirable passage of fluids between components 14 and 18.

As shown in FIG. 1, the outer surface of connector end component 14 may include a plurality of threads 48 that may be used to couple the hose 12 to a desired component of a hydraulic system. Wrench flats 16 may also be provided to assist with the threading of the swivel connector 10 into the desired hydraulic components.

Assembly of the hydraulic swivel connector 10 of the present invention may be accomplished as follows:

First, the portion of the swivel spud 18, including barbs 42, is inserted into a length of flexible tube or pipe 12. Next, as shown in FIG. 2, collar or shell 46 is disposed about hose 12 substantially adjacent to the portion of the swivel spud 18 inserted in the hose 12. Next, the fastener or snap ring 28 (see FIG. 5) is loaded into the external circumferential groove 26 on second exterior surface region 22 of the swivel spud 18. The sealing means or o-ring(s) are inserted into the second interior surface region 34 of the connector end component 14 as shown in FIG. 7. Preferably, the o-ring 40 is abutted against a lip formed by the differing diameters of regions of the second interior region 34 and third interior surface region 36. Preferably, the inside diameter of the seal is lubricated to facilitate the ease of installation of swivel spud 18. Next, the swivel spud 18 is aligned with the cavity of connector end component 14. The fastener means or snap ring 28 is centered within the chamferred region 44 of the connector end component 14.

By pressing the swivel spud 18 into the aligned cavities of the connector end component 14, the snap ring 28 is contained by the swivel spud 18 is caused to be collapsed by the chamferred region 44 of the connector end component 14 into the external circumferential groove 26 of the swivel spud 18. When additional force is applied to the swivel spud 18 longitudinally into the cavity of the connector end component 14, it causes the swivel spud external circumferential groove 26 (with collapsed snap ring 28) to become aligned substantially directly under the connector end component internal circumferential groove 38. Accordingly, the snap ring within groove 26 expands to partially move into the groove 38 in the connector end component. As a result, the snap ring 28 is contained in part by each of the grooves 26 and 38 in such a manner to rotatably connect connector end component 14 and swivel spud 18. Preferably, the sealing member or o-ring 40 is fixedly contained between the first exterior surface region 20 of the swivel spud 18 and the third interior surface region 36 of the connector end component 14 so as to provide a complete seal gland within which the seal effectively permanently seals the system hydraulic fluids.

Preferably, the internal surfaces of the connector end component are machined or bored to receive corresponding regions of swivel spud 18. Preferably the swivel spud 18 is comprised of any material suitable for the hydraulic system operating environment. More preferably, the swivel spud 18 is made of 316 stainless steel. The first exterior surface region 20 is used, as described previously, as a bearing surface to ride within the interior of connector end component 14. Exterior surface region 20 also acts as a sealing surface upon which the sealing component or o-ring 40 rides. The second exterior surface region 22 of the swivel spud acts a secondary bearing surface to rotate within the secondary cavity defined by the third interior surface region 36 of the connector end component 14. Preferably, the external circumferential groove 26 of the swivel spud 18 is of sufficient depth so as to fully accept the compressed snap ring 28 during assembly of the hydraulic swivel connector 10 of the present invention.

Although the hydraulic swivel connector 10 of the present invention has been described for use with a flexible metal hose 12, other fluid conduits such as rubber, plastic hoses, and rigid tubes are suitable for use with the present invention. Additional fastening means other than the snap ring 28 described in the present invention include ball bearings, wires, or threaded fasteners such as screws and bolts. Suitable seal compounds compatible for use with the hydraulic swivel connector of the present invention include standard oil based hydraulic fluids, synthetic hydraulic fluids, and water hot oil transfer fluids. Various seal configurations may be used with the hydraulic swivel connector of the present invention depending on whether it is a high or low pressure application being contemplated. Similarly, the specific configurations of the hydraulic swivel connector may vary depending on the associated torque swivel action of the particular hydraulic system contemplated. Preferably, the various components of the present invention are metal. Most preferably, the components are comprised of stainless steel. Any other suitably durable material may be used, however, such as steel, brass, or durable plastics. The connector end component 14, in addition to threads 48 and wrench flats 16, may include flanges, bend configurations, or any other standard coupling mechanism to assist in the linkage of a fluid conduit 12 to a desired hydraulic system component.

The hydraulic swivel connector of the present invention advantageously provides an essentially permanently attached live swivel to a hydraulic conduit. Accordingly, this minimizes or eliminates the need for adapters which result in a reduced chance of leakage due to fewer assembly joints present in the system. The hydraulic swivel connector device of the present invention also provides for ease of installation and advantageous reductions in assembling time and induced hose stress resulting from the lack of adapters. The hydraulic swivel connector of the present invention also relieves hose stress associated with hydraulic system vibration and reduces side loading and wear of hydraulic system drains and components. The hydraulic swivel connector of the present invention can be sealed with a variety of compounds and configurations specific to the requirements of the relevant application. The hydraulic swivel connector of the present invention results in a joint that offers increased useable hose length and assembly flexibility. Accordingly, this minimizes or eliminates hose assembly twist and resultant hose damage and extends rotary joint life.

The foregoing description of a preferred embodiment of the invention has been presented for the purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

What is claimed is:

1. A hydraulic swivel connector comprising:
a) a swivel spud, said swivel spud comprising an interior surface and an exterior surface, said exterior surface further comprising a first region having a first diameter, a second region having a second diameter greater than said first diameter of said exterior surface of said swivel spud, and a third region having a third diameter greater than said second diameter of said exterior surface of said swivel spud, said second region further comprising an external circumferential groove;
b) a connector end component, said connector end component comprising an interior surface and an exterior surface, said interior surface of said connector end component comprising a first region having a first diameter, a second region having a second diameter greater than said first diameter of said connector end component, and a third region having a third diameter greater than said second diameter of said connector end component, said third region of said interior surface of said connector end component comprising an internal circumferential groove, at least a portion of said swivel spud adapted to be rotatably received within said connector end component;
c) sealing means disposed between said swivel spud and said connector end component; and
d) fastener means adapted to retain said swivel spud rotatably within said connector end component.

2. The hydraulic swivel connector of claim 1 wherein said fastener means comprises one or more snap rings.

3. The hydraulic swivel connector of claim 2 wherein said sealing means comprises one or more resilient o-rings.

4. The hydraulic swivel connector of claim 3 wherein said snap ring is discontinuous.

5. The hydraulic swivel connector of claim 1 wherein said outer surface of said connector end component comprises a plurality of threads adapted to be received within corresponding mating threads of a rotatable hydraulic system component.

6. The hydraulic swivel connector of claim 5 wherein said outer surface of said connector end component comprises a plurality of wrench flats.

7. The hydraulic swivel connector of claim 1 wherein said connector end component further comprises a chamferred region adapted to provide leverage to compress the fastener means within said external circumferential groove during assembly of said hydraulic swivel connector.

8. The hydraulic swivel connector of claim 7 wherein said swivel spud comprises a plurality of barbs adapted to be received within a fluid conduit.
